(19) United States
(12) Patent Application Publication
(10) Pub. No.: US 2006/0077654 A1
(43) Pub. Date: Apr. 13, 2006

(54) Lighted vanity mirror kit

(75) Inventors: Michael Krieger, Miami Beach, FL (US); Kevin Ellsworth, Hollywood, FL (US)

Correspondence Address: VENABLE LLP, P.O. BOX 34385, WASHINGTON, DC, 20045-9998, US

(73) Assignee: Vector Products, Inc., Ft. Lauderdale, FL (US)

(21) Appl. No.: 11/242,073

(22) Filed: Oct. 4, 2005

Related U.S. Application Data
(60) Provisional application No. 60/616,847, filed on Oct. 8, 2004.

(51) Int. Cl. F21V 33/00

(52) U.S. Cl. 362/136; 362/183; 362/142

(57) ABSTRACT

A vanity mirror kit comprises a housing including movable components and a storage compartment. A mirror is attached to the housing and is moveable between a deployed position and a stowed position in which the mirror is located in the storage compartment. The movable components have a closed position in which the storage compartment is enclosed within the housing and an open position in which the storage compartment is open permitting deployment of the mirror. A light is adapted to illuminate the mirror. A power source is located in the housing and is adapted to power the light.

### CROSS-REFERENCE TO RELATED APPLICATIONS

This application claims priority under 35 U.S.C. § 119(e) of U.S. Provisional Patent Application No. 60/616,847, filed on Oct. 8, 2004, the entire content of which is incorporated herein by reference.

### BACKGROUND OF THE INVENTION

1. Field of the Invention

The present invention relates generally to expandable and collapsible vanity mirror kits, and more specifically, to such vanity mirror kits including a light source for the mirror.

2. Related Art

Today's active lifestyle often leads to people carrying out tasks simultaneously, or in alternative or non-traditional locations. Along these lines, many people eat meals or work in their car rather than at home or in an office. Also, it is not uncommon to see men and women carry out grooming tasks in non-traditional locations, such as in a car. For example, men can be seen shaving while looking in the rearview mirror, while women can often be seen applying makeup in a car. Carrying out tasks in alternative locations requires that people have the necessary resources to be able to carry out the tasks. For example, when working outside the office, people may need a portable computer, wireless internet access, as well as paper, writing implements and other accessories. On the other hand, grooming tasks may require a mirror and accessories, such as a razor, makeup, or other items.

Carrying out many tasks on the run leads to carrying around many associated accessories necessary to engage in the tasks. Carrying around so many accessories may result in a need to organize the accessories so that they are retrievable when needed. Otherwise, time needed for other tasks can be wasted in determining the location of needed accessories.

### SUMMARY OF THE INVENTION

One exemplary embodiment of the present invention relates to a vanity mirror kit, comprising: a housing including movable components and a storage compartment; a mirror attached to the housing and moveable between a deployed position and a stowed position in which the mirror is located in the storage compartment, wherein the movable components have a closed position in which the storage compartment is enclosed within the housing and an open position in which the storage compartment is open permitting deployment of the mirror; a light adapted to illuminate the mirror; and a power source located in the housing and adapted to power the light. The power source can be a battery located in the housing. Alternatively, the power source can be a power cord adapted to connect to an external power source. The power cord can include a plug adapted to be inserted in a cigarette lighter receptacle. Alternatively, the power cord can include a plug adapted to be inserted in an AC power receptacle.

The mirror can include a first side comprising a magnifying mirror, and a second side comprising a non-magnifying mirror.

The mirror can articulate about a first axis and a second axis. The first axis can be substantially parallel to the second axis. Additionally or alternatively, the mirror can pivot about a third axis that is transverse to the first axis and the second axis. Additionally or alternatively, the first axis can be separated from the second axis by a support member.

Another exemplary embodiment of the present invention relates to a vanity mirror kit, comprising: a housing including a mirror storage compartment and at least one accessory storage compartment that articulates with respect to the mirror storage compartment between an open position and a closed position; a first support member that articulates with respect to the housing; a second support member that articulates with respect to the first support member; a mirror mounted to the second support member; and a light associated with the mirror.

Further objectives and advantages, as well as the structure and function of exemplary embodiments will become apparent from a consideration of the description, drawings, and examples.

### BRIEF DESCRIPTION OF THE DRAWINGS

The foregoing and other features and advantages of the invention will be apparent from the following, more particular description of an exemplary embodiment of the invention, as illustrated in the accompanying drawings wherein like reference numbers generally indicate identical, functionally similar, and/or structurally similar elements.

FIG. 1 depicts an exemplary embodiment of a vanity mirror kit according to the present invention in an expanded position; and

FIG. 2 depicts the vanity mirror kit of FIG. 1 in a collapsed or stowed position.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention.

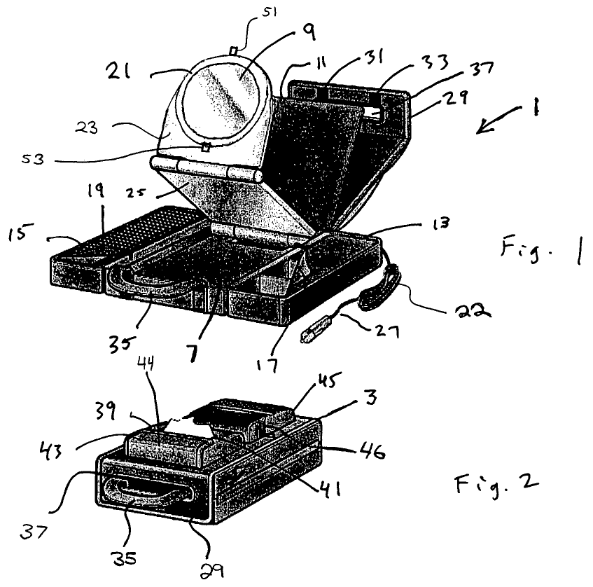

Referring to FIGS. 1 and 2, an exemplary embodiment of a vanity mirror kit 1 according to the present invention is shown. The vanity mirror kit 1 includes an expandable housing 3. The expandable housing 3 can be made of plastic, metal, cellulosic materials, such as cardboard, composite and/or other materials. At least a portion of the exterior of the expandable housing 3 can be covered with a covering layer 5 of material. For example, at least a portion of the exterior can be covered with a fabric covering. The fabric can be woven or non-woven, natural and/or synthetic. The surface of the covering can be contoured and/or textured to provide a non-slip characteristic to the cover and/or a soft feel. At least a portion of a covering can include padding. One portion of the expandable housing 3 that can include padding is the bottom. The padding can act as a cushion between the vanity mirror kit 1 and whatever surface the kit 1 is set on. The padding can also act to cushion the kit 1 if it is dropped.

The expandable housing 3 can include a mirror storage compartment 7 in which one or more mirrors 9 can be stored when the housing 3 is in a collapsed state (shown in FIG. 2). Other elements and/or accessories can also be stored in the mirror storage compartment 7.

The vanity mirror kit 1 can include a mirror storage compartment cover 11. The cover 11 can act to protect the mirror 9 from impacts, to minimize the risk of accidental exposure of the mirror 9, and/or to prevent accidental opening of the mirror storage compartment 7. The mirror storage compartment cover 11 can be attached to the mirror storage compartment 7 by hinges, and can move between an open or expanded position in which the mirror 9 can be deployed (as shown in FIG. 1) and a closed or stowed position in which the mirror 9 is stowed.

One or more storage compartments 13, 15 can be interconnected with the mirror storage compartment 7. The storage compartments 13, 15 can accommodate items such as grooming accessories or other related or unrelated accessories. For example, make-up, grooming implements, such as combs, brushes and make-up application implements, and/or other items can be stored in the storage compartments 13, 15.

The storage compartment 13, 15 can be attached to the mirror storage compartment 7 in a manner that permits the storage compartments to be moveable between a stowed or collapsed position shown in FIG. 2 and an expanded position shown in FIG. 1, regardless of the structure interconnecting the mirror and the expandable housing. For example, storage compartment 13 and/or 15 can be attached to mirror storage compartment 7 with hinges.

While vanity mirror kit 1 is shown in FIGS. 1 and 2 as having two storage compartments 13, 15, other embodiments with more, less, or no storage compartments are possible. If vanity mirror kit 1 has only one accessory storage compartment, then it can be preferable for the single storage compartment to have a cross-sectional area that is equivalent to that of the mirror storage compartment 7. This configuration can allow the single storage compartment to completely cover the mirror storage compartment 7, with the sides of each aligned when in a stowed or collapsed position, and permit the bottom surfaces of both to be co-planar, or substantially co-planar when in an opened or expanded position or configuration. A single storage compartment can be joined to one side of the mirror storage compartment 7, for example, by a hinge.

In the exemplary embodiment shown in FIGS. 1 and 2, the storage compartments 13, 15 each have a depth similar to the mirror storage compartment 7, and a width about one-half of the width of the mirror storage compartment 7. This configuration allows the storage compartments 13, 15 to fold on top of the mirror storage compartment 7 when in the closed position, as shown in FIG. 2. In alternative embodiment, the storage compartments 13, 15 can have dissimilar widths.

The vanity mirror kit 1 is not limited to the shape and configuration shown in FIG. 1. For example, it can alternatively include more than two storage compartments. For example, each of the storage compartments 13, 15 shown in FIG. 1 can be replaced with two or more storage compartments. The storage compartments can also be attached elsewhere on the mirror storage compartment 7. Additionally, the storage compartments can have other shapes, such as square, triangular, or otherwise. Furthermore, the storage compartments can be shallower than the embodiments shown in FIG. 1. Other dimensions and characteristics of the storage compartments can vary without departing from the invention.

To facilitate retention of the grooming and/or other accessories, the storage compartments 13, 15 can each include a cover 17, 19, respectively. The covers 17, 19 can include flexible and/or rigid portions. The covers 17, 19 can be a solid or mesh woven or non-woven fabric, a plastic sheet, a hard plastic member, cardboard and/or any other composition.

The covers 17, 19 can be attached to the storage compartments 13, 15 in a variety of ways, for example, by hinges. Alternatively, the covers 17, 19 can be attached using adhesives, by sewing the covers 17, 19 to a cover on the outside of the storage compartments 13, 15, by welding plastic together, or by any other method known in the art. Hook and loop type material can also be used to hold the covers 17, 19 on the storage compartment 13, 15. The cover members 17, 19 can be closed utilizing a zipper, hook and loop closure, magnetic closure, zip closure (as in plastic bags), mechanical closure, such as a latch, or any other suitable closure.

As discussed above, the vanity mirror kit 1 can include at least one mirror 9. The mirror 9 can be, for example, normal, magnifying, or reducing. In the exemplary embodiment shown in FIGS. 1 and 2, two mirrors are provided back-to-back, one of which is a normal mirror, and the other of which is a magnifying mirror, although other configurations are possible. The mirror 9 can be expandable and/or adjustable.

The vanity mirror kit 1 can also include one or more lights 21 that produce light to illuminate the mirror 9, allowing use of mirror 9 in dark or dim lighting conditions. Any type of light source can be utilized, such as incandescent, fluorescent, or LED. Also, one or more light sources can be included. For example, a string of lights can be arranged about the mirror 9, or a single light can extend about all or a portion of the perimeter of the mirror 9. In the exemplary embodiment shown in FIG. 1, the light 21 is arranged around the mirror 9, and is integrated into the mirror housing.

According to an alternative embodiment, the light can be arranged on a separate support. For example, the light can be arranged on a light support, which can be, for example, a flexible member extending from the housing. Alternatively, the light support can include one or more sections connected together by joints. In either case, the light can be attached to the support with a universal joint. An articulated, flexible support or a jointed support and/or a universal mounting of the light can provide the light with flexibility to direct light where needed. A light on a support can also be provided in addition to a light 21 surrounding the mirror 9.

The vanity mirror kit 1 can include one or more mirror support members to support the mirror 9, and/or to permit the mirror 9 to be arranged in a variety of locations, including a stowed position and a variety of deployed positions (such a shown in FIG. 1). During use, the mirror 9 is typically arranged in a location that provides a favorable view of the person using the mirror.

FIG. 1 illustrates an embodiment including a first mirror support member 25 and a second mirror support member 23. One or more of support members 23, 25 can have a planar configuration as shown in FIG. 1. Such elements can provide greater stability to the mirror 9, provide a strong connection to the expandable housing 3, and facilitate collapsing the mirror 9 into the expandable housing 3. In the exemplary embodiment shown in FIG. 1, the first support member 25 is connected to expandable housing 3, for example, with hinges or some other structure, that allows first support member 25 to articulate with respect to expandable housing 3 about a first axis. Second support member is similarly connected to the first support member 25, and pivots with respect thereto about a second axis. In the exemplary embodiment of FIG. 1, the first axis and the second axis are substantially parallel to one another, however, other configurations are possible.

In the exemplary embodiment shown in FIG. 1, the mirror 9 is mounted to the second support member 23 such that it can pivot with respect to the second support member 23. For example, the mirror 9 can be mounted to second support member 23 with pivot joints 51, 53, which are located opposite one another at the top and bottom of mirror 9. This configuration allows the mirror 9 to pivot with respect to the second support member 23 about a third axis, which can be transverse, or preferably, perpendicular to the first and second axes. Accordingly, a user can adjust the angle of the mirror 9 up-and-down, as well as side-to-side. Alternatively, the pivot joints 51, 53 can be located at opposite sides of mirror 9, allowing for additional up-and-down adjustment of mirror 9. According to another alternative embodiment, the mirror 9 can be connected with one of the support members 23, 25 by a universal joint. The universal joint can be attached to a location on the perimeter of the mirror, the back of the mirror, or anywhere else that permits the mirror to move.

Alternative embodiments of mirror mounting elements can include one or more arms interconnecting the mirror 9 with the expandable housing 3. The arm(s) can be connected to the mirror, mirror support, and/or the expandable housing with joints that permit the arm(s) to move with one or more degrees of freedom. Such joints can include hinged connections that permit movement back and forth in one direction, universal joints, such as ball joints, or other joints. Folding arms can make the vanity mirror kit 1 more compact and/or provide additional space within the expandable housing 3 for other elements.

The vanity mirror kit 1 can include a power source, for example, to power the light 21. The power supply can include one or more batteries, which can be stored in the mirror storage compartment 7, one of the accessory storage compartments 13, 15, or some other portion of expandable housing 3. Alternatively, the power source can comprise a power cord 22 adapted to connect to an external power source. Some examples of possible external power sources include an external battery, such as a car battery, a power outlet, such as a AC power receptacle connected to the public power grid, solar panels, or other known power supplies. To connect the kit to a DC power supply, the cord 22 can have a plug 27 adapted to be inserted in a cigarette lighter receptacle, for example, of the type found in automobiles. Alternatively or additionally, the plug 27 can be adapted to be inserted in an AC power receptacle, such as the type commonly found in houses. When not in use, cord 22 and/or plug 27 can be stowed within the expandable housing 3, for example, in the mirror storage compartment 7, or in one of the accessory storage compartments 13, 15. The vanity mirror kit 1 can additionally include a power converter or transformer to ensure that the power supplied to the light 9, or other device, is the proper voltage, amperage, etc. Such a converter or transformer can be located within the mirror storage compartment 7, in one of the accessory compartments 13, 15, or some other part of housing 3.

Vanity mirror kit 1 can include one or more cover members, such as the cover 29 shown in FIGS. 1 and 2. The cover(s), if provided, can retain elements, such as the mirror 9 and/or storage compartments 13, 15, in the stowed positions when the kit 1 is in a non-expanded state. The cover(s) can be attached to the kit 1, for example, with hinges. If cover 29 is provided, vanity mirror kit 1 can also include one or more closing elements to secure the cover 29 in the closed position. Suitable closing elements can include hook and loop closures, a zipper, a magnetic closure, a zip closure (as in plastic bags), a mechanical closure, such as a latch, or any other known closure device. The exemplary embodiment of FIGS. 1 and 2 utilizes two hook and loop closures 31 and 33 as the closing elements.

The vanity mirror kit 1 can also include one or more handles to facilitate transporting the vanity mirror kit 1, such as the handle 35 in the exemplary embodiment of FIGS. 1 and 2. The handle(s) can be attached to any location on the exterior of the vanity mirror kit 1. The handle(s) can also act together with the cover to retain the vanity mirror kit in a closed arrangement. For example, as shown in FIGS. 1 and 2, the cover 29 can include an opening 37 that receives the handle 35. When carrying the kit 1, the interconnecting relationship between handle 35 and the opening 37 in cover 29 can prevent the vanity mirror kit 1 from opening, spilling its contents, and/or possibly exposing the mirror 9 to breakage.

Vanity mirror kit 1 can also include various elements located on the exterior of the kit. Such elements can be attached to the cover 29, one of the storage compartments, or other portions. For example, as shown in FIG. 2, kit 1 can have a compartment 39 for holding a box of tissues or other items. Tissue compartment 39 can include an opening 43 for receiving the tissue box and an opening 41 for dispensing tissues. A closure flap 44 can be provided to help retain the tissue box in the compartment 39. The closure flap can be secured in a closed position with any suitable closing elements, such as hook and loop closures, a zipper, magnetic closure, zip closure (as in plastic bags), mechanical closure, such as a latch, or any other suitable closure. The exemplary embodiment shown in FIGS. 1 and 2 also includes another accessory compartment 45 attached to the cover 29. The accessory compartment 45 can include a closure, such as the zipper 46 shown in FIG. 2, although any other known closure, such as those described above, can be utilized.

The various internal and external compartments described above, such as, for example, the tissue compartment 39, the accessory compartment 45, the storage compartments 13, 15, and/or the mirror storage compartment 7 can accommodate any items and are not limited to storing grooming items exclusively. For example, mobile phones and accessories, travel documents, office supplies, snacks, candy, and/or any other items can be stored in the compartments.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention can be modified or varied, without departing from the invention, as appreciated by those skilled in the art in light of the above teachings. It is therefore to be understood that, within the scope of the claims and their equivalents, the invention can be practiced otherwise than as specifically described.

What is claimed:

1. A vanity mirror kit, comprising:
a housing including movable components and a storage compartment;
a mirror attached to the housing and moveable between a deployed position and a stowed position in which the mirror is located in the storage compartment, wherein the movable components have a closed position in which the storage compartment is enclosed within the housing and an open position in which the storage compartment is open permitting deployment of the mirror;
a light adapted to illuminate the mirror; and
a power source located in the housing and adapted to power the light.

2. The vanity mirror kit of claim 1, wherein the power source is a battery located in the housing.

3. The vanity mirror kit of claim 1, wherein the power source is a power cord adapted to connect to an external power source.

4. The vanity mirror kit of claim 3, wherein the power cord includes a plug adapted to be inserted in a cigarette lighter receptacle.

5. The vanity mirror kit of claim 3, wherein the power cord includes a plug adapted to be inserted in an AC power receptacle.

6. The vanity mirror kit of claim 1, wherein the mirror includes a first side comprising a magnifying mirror, and a second side comprising a non-magnifying mirror.

7. The vanity mirror kit of claim 1, wherein the mirror articulates about a first axis and a second axis.

8. The vanity mirror kit of claim 7, wherein the first axis is substantially parallel to the second axis.

9. The vanity mirror kit of claim 8, wherein the mirror pivots about a third axis that is transverse to the first axis and the second axis.

10. The vanity mirror kit of claim 7, further including a support member separating the first axis from the second axis.

11. The vanity mirror kit of claim 1, wherein the storage compartment comprises a mirror storage compartment, and the housing further comprises at least one accessory storage compartment that articulates with respect to the mirror storage compartment.

12. A vanity mirror kit, comprising:
a housing including a mirror storage compartment and at least one accessory storage compartment that articulates with respect to the mirror storage compartment between an open position and a closed position;
a first support member that articulates with respect to the housing;
a second support member that articulates with respect to the first support member;
a mirror mounted to the second support member; and
a light associated with the mirror.

13. The vanity mirror kit of claim 12, further comprising a power source located in the housing and adapted to supply power to the light.

14. The vanity mirror kit of claim 13, wherein the power source is a battery located in the housing.

15. The vanity mirror kit of claim 13, wherein the power source is a power cord adapted to connect to an external power source.

16. The vanity mirror kit of claim 15, wherein the power cord includes a plug adapted to be inserted in a cigarette lighter receptacle.

17. The vanity mirror kit of claim 15, wherein the power cord includes a plug adapted to be inserted in an AC power receptacle.

18. The vanity mirror kit of claim 12, wherein the mirror includes a first side comprising a magnifying mirror, and a second side comprising a non-magnifying mirror.

19. The vanity mirror kit of claim 12, wherein the first support member articulates with respect to the housing about a first axis and the second support member articulates with respect to the first support member about a second axis that is substantially parallel to the first axis.

20. The vanity mirror kit of claim 19, wherein the mirror pivots with respect to the second support member about a third axis that is transverse to the first axis and the second axis.

21. The vanity mirror kit of claim 14, wherein the battery is a rechargeable battery, and further including a DC input for connection to a DC power source for recharging the battery.
